(19) United States
(12) Patent Application Publication
(10) Pub. No.: US 2026/0231000 A1
(43) Pub. Date: Aug. 6, 2026

(54) BUFFER STATUS REPORTING ENHANCEMENTS TO SUPPORT THE SENDING OF DATA

(71) Applicant: InterDigital Patent Holdings, Inc., Wilmington, DE (US)

(72) Inventors: Oumer Teyeb, Montreal (CA); Faris Alfarhan, Montreal (CA); Ghyslain Pelletier, Montreal (CA); Diana Pani, Montreal (CA); Yugeswar Deenoo Narayanan Thangaraj, Chalfont, PA (US); Dylan Watts, Montreal (CA)

(73) Assignee: InterDigital Patent Holdings, Inc., Wilmington, DE (US)

(21) Appl. No.: 19/046,424

(22) Filed: Feb. 5, 2025

(51) Int. Cl. H04W 48/08; H04W 28/02; H04W 72/1268

(52) U.S. Cl. CPC H04W 48/08; H04W 28/0278; H04W 72/1268

(57) ABSTRACT

A wireless transmit/receive unit (WTRU) may receive configuration information including an indication of one or more conditions associated with collected data. The indication of the one or more conditions associated with the collected data may include an indication of a volume threshold. The WTRU may collect data and/or compare collected data to the volume threshold. Based on the comparison of the collected data to the volume threshold for example, the WTRU may perform one or more of allow access to the collected data to one or more lower layers, transmit an indication to a network that the collected data is ready for transmission, allow information associated with the collected data to the one or more lower layers, and/or restrict access to the one or more lower layers to the collected data.

### BACKGROUND

Artificial intelligence/machine learning (AI/ML) may be integrated into a network, for example a into fifth generation (5G) new radio (NR) network. AI/ML may enhance air-interface performance (e.g., improved throughput, robustness, accuracy or reliability, etc.) and/or reduce complexity/overhead. AI/ML may impact beam management, positioning, and CSI prediction.

Artificial intelligence (AI) may include behavior exhibited by machines that, for example may mimic cognitive functions to sense, reason, adapt, and/or act. Machine learning (ML) may include algorithms (e.g., types of algorithms) that solve a problem based on learning through experience (e.g., data), for example without being explicitly programmed (e.g., configuring a set of rules). ML may be a subset of AI. Different ML paradigms may be envisioned, for example based on the nature of data or feedback available to the learning algorithm. A supervised learning approach may involve learning a function that maps input to an output based on labeled training example. A (e.g., each) training example may include a pair. The pair may include an input and a corresponding output. An unsupervised learning approach may involve detecting patterns in the data with no pre-existing labels. A reinforcement learning approach may involve performing a sequence of actions in an environment, for example to maximize the cumulative reward. ML algorithms may be applied using a combination and/or interpolation of the approaches herein. For example, a semi-supervised learning approach may use a combination of a small amount of labeled data with a large amount of unlabeled data during training. Semi-supervised learning may fall between unsupervised learning (e.g., with no labeled training data) and supervised learning (e.g., with only labeled training data).

### SUMMARY

A WTRU may be configured to determine whether collected data is made available to lower layers and/or included in data volume calculations, for example based on conditions/thresholds. The WTRU may be configured to determine whether a buffer status report (BSR)/scheduling request (SR) should be triggered, for example due to the availability of collected data based on conditions/thresholds. Additionally, or alternatively, the WTRU may be configured to determine whether the BSR/SR should be triggered implicitly or explicitly. The WTRU may trigger the BSR/SR implicitly by modifying the logical channel priority. The WTRU may trigger the BSR/SR explicitly by enabling/disabling the BSR/SR triggering.

Example conditions may include network conditions and/or WTRU conditions. Example network conditions may include radio signal level. Example WTRU conditions may include current level of buffer occupancy associated with the data collection, the activity level of other bearers, reception of a request to report collected data from network and/or OTT server, and/or time since data collection started, etc.

A WTRU may receive configuration information. The configuration information may include an indication of one or more conditions, for example associated with collected data. For example the indication of the one or more conditions associated with the collected data may include an indication of a volume threshold. The WTRU may collect data and/or compare collected data to the volume threshold. Based on the comparison of the collected data to the volume threshold for example, the WTRU may perform one or more of allow access to information associated with the collected data to one or more lower layers, transmit an indication to a network that the collected data is ready for transmission, allow information associated with the collected data to the one or more lower layers, and/or restrict access to the one or more lower layers to the collected data. The WTRU may, for example based on the comparison of the collected data to the volume threshold, allow access to the collected data to the one or more lower layers.

The one or more lower layers may include a packet data convergence protocol (PDCP) and/or a radio link control (RLC) layer. The WTRU may receive an uplink (UL) grant. The WTRU may transmit the collected data to the network, for example via resources indicated by the UL grant. The WTRU may determine that the one or more conditions are not satisfied. Based on the determination that the one or more conditions are not satisfied for example, the WTRU may restrict access to the collected data.

The WTRU may restrict access to the one or more lower layers to the collected data, for example for performing a data volume calculation. The WTRU may suspend a data collection bearer, for example based on the collected data being below the volume threshold. The WTRU may disable a triggering of a buffer status report (BSR) and/or scheduling request (SR), for example based on the collected data being below the volume threshold.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is an example diagram of a system architecture 200.

### DETAILED DESCRIPTION

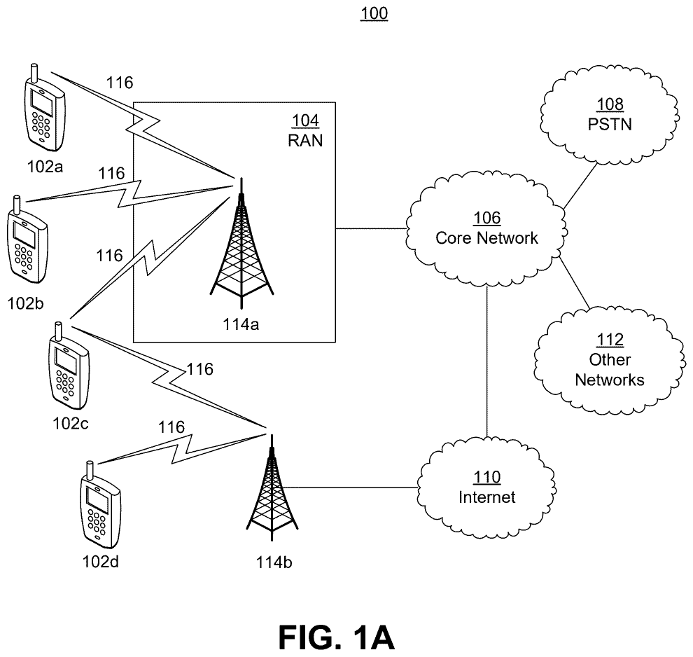

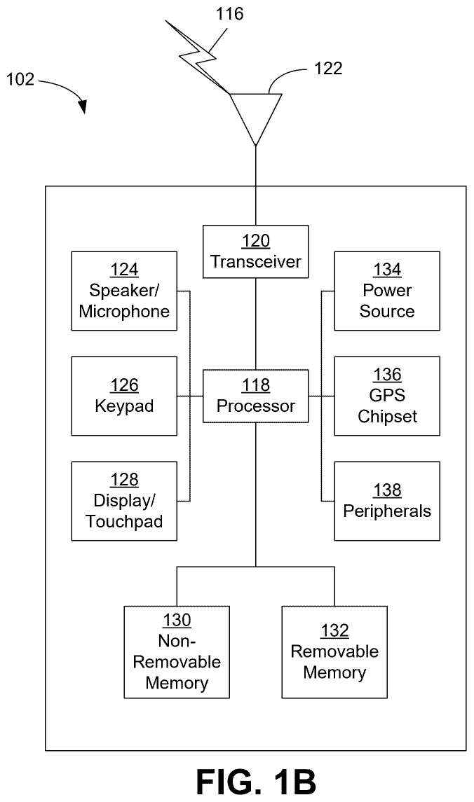

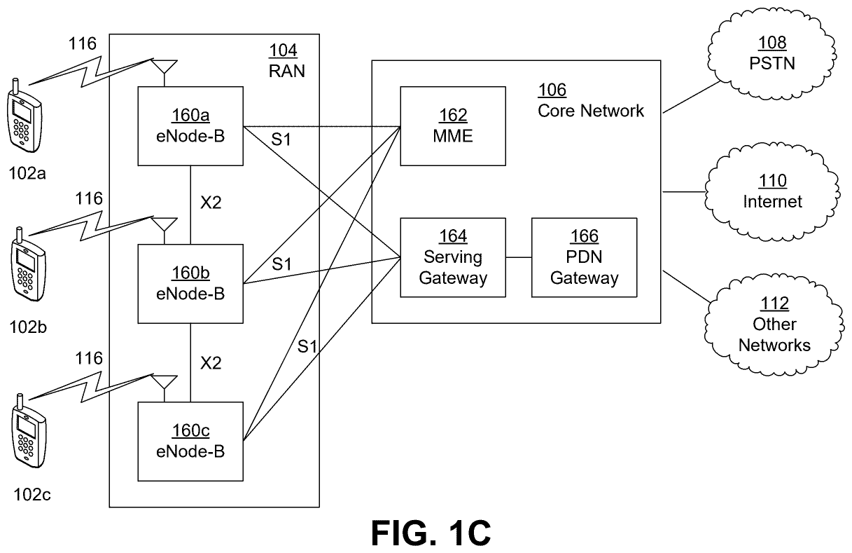

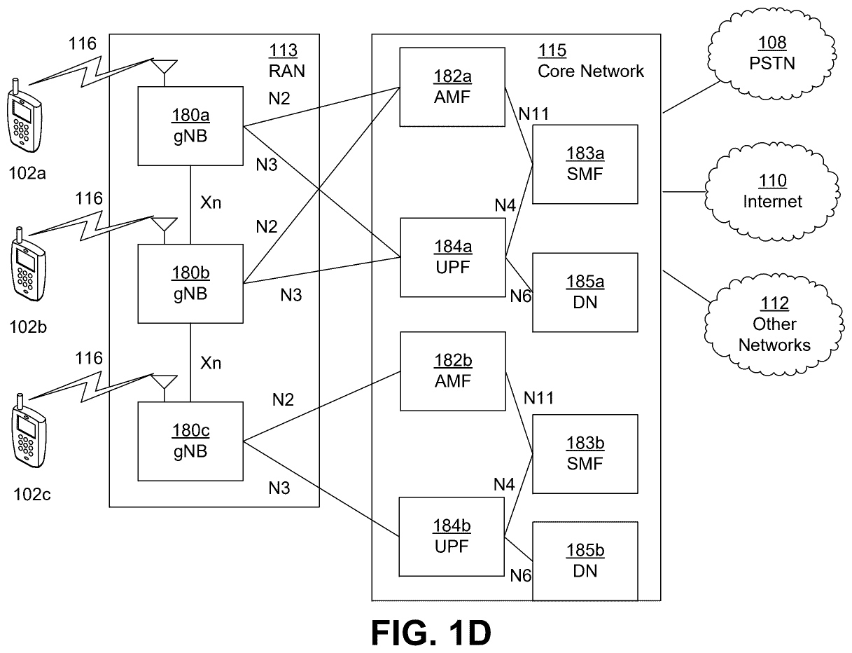

FIG. 1A is a diagram illustrating an example communications system 100 in which one or more disclosed embodiments may be implemented. The communications system 100 may be a multiple access system that provides content, such as voice, data, video, messaging, broadcast, etc. to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU. Further, any description herein that is described with reference to a UE may be equally applicable to a WTRU (or vice versa). For example, a WTRU may be configured to perform any of the processes or procedures described herein as being performed by a UE (or vice versa).

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc. and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Framework for supporting use cases may include wireless transmit/receive unit (WTRU)-side and/or NW-side data collection. Data collection may be performed for purposes in life cycle management (LCM), for example for model training, model inference, model monitoring, model selection, and/or model update. Example purposes may have different requirements and/or potential specification impact.

Data collection may be used for training of a network side or a WTRU sided model. Data may be collected for the training of a network sided model, for example based on (e.g., immediate) minimization of drive test (MDT) (e.g., sent via RRC signaling). Additionally, or alternatively, a low priority signaling radio bearer (SRB) may be used. A WTRU may send an availability indication when data is available. A Network may request the collected data on demand (e.g. using UEInformationRequest/response messaging). Large amounts of data may be sent, for example in multiple requests, and/or one request followed by multiple responses, etc. A WTRU may stop/pause the data collection when a buffer limit is reached. A WTRU may indicate to the network before/when the buffer becomes full (e.g., a percentage of buffer size). A WTRU may send an indication of a power problem and/or to stop/pause the data collection. Periodic and/or event based logging may be supported (e.g., events based on radio conditions).

Data may be collected for the training of a WTRU sided model. For example a WTRU may collect and/or (e.g., directly) transfer training data to an over-the-top (OTT) server. The OTT server may be transparent or non-transparent. A WTRU may collect training data and/or transfer the training data to a core network (CN). The CN may transfer the training data to the OTT server. A WTRU may collect training data and/or transfers it to operations, administration, and maintenance (OAM). OAM may transfer the (e.g., needed) data to the OTT server.

Systems and methods may include buffer status reporting (BSR). Uplink (UL) buffer status reports (BSR) may provide support for quality of service (QoS)-aware packet scheduling. In NR for example, BSR may be reported at a logical channel group (LCG) granularity. A WTRU may be configured with up to 32 logical channel IDs (LCID) in some examples. The LCIDs may be grouped into as many as 8 LCGs in some examples. A WTRU may be configured with more than 32 LCIDs and/or more than 8 LCGs. For example the mobile termination (MT) of an integrated backhaul access (IAB) node may be configured with up to 65855 LCIDs and/or 256 LCGs.

A BSR may be sent using a medium access control (MAC) control element (CE). The BSR may be sent in a short BSR format and/or a long BSR format. The short BSR format may be used to report the data for only one LCG for example. The long BSR format may be used to report the data from multiple (e.g., several) LCGs.

A WTRU may transmit a BSR using MAC CEs. A BSR is triggered, for example when new data arrives in the transmission buffers of the WTRU. If the WTRU does not have any available UL grants to send the BSR when a BSR is triggered for example, the WTRU may transmit a scheduling request (SR) to request the needed UL resources to transmit the BSR.

The MAC entity may determine the amount of UL data available for a logical channel, for example according to a data volume calculation procedure performed at radio link control (RLC) and/or packet data convergence protocol (PDCP).

RLC may include the RLC data PDUs that are pending transmission and/or retransmissions, RLC SDUs and/or segments of RLC SDUs that have not been included in an RLC data PDU, and/or any pending RLC STATUS PDU, for example when performing a data volume calculation. The data volume calculation at PDCP may be based on (e.g., consider) the PDCP SDUs for which PDCP data PDUs have not been constructed, PDCP data PDUs that have not been transmitted to lower layers yet, any PDCP control PDUs, and/or any PDPC SDUs or PDUs that are to be retransmitted due to PDCP re-establishment or PDCP data recovery.

A WTRU may trigger a BSR when one or more events occur. An example events may include UL data for a logical channel which belongs to an LCG becoming available to the MAC entity. The UL data may belong to a logical channel with a higher priority than the priority of a (e.g., any) logical channel containing available UL data which belongs to a (e.g., any) LCG. Additionally, or alternatively, none of the logical channels which belong to an LCG may contain (e.g., any) available UL data. The example event where UL data for a logical channel which belongs to an LCG becoming available to the MAC entity may be referred to as regular BSR.

Another example event may include UL resources being allocated when the WTRU has less data that resources allow the WTRU to send and the number of padding bits is equal to or greater than a size of the BSR MAC CE plus a subheader. This example event may be referred to as padding BSR.

Another example event may include a timer expiring. For example a retxBSR-Timer may expire and at least one of the logical channels which belongs to an LCG may contain UL date. This example event may be referred to as regular BSR. Another example event may include a periodicBSR-Timer expiring. This example event may be referred to as periodic BSR.

A (e..g, each) logical channel may trigger one separate regular BSR, for example when regular BSR triggering events occur for multiple logical channels simultaneously. BSRs may be sent per LCG, for example rather than per logical channel (LCH). In some examples an LCG may be associated with only a single LCH. LCHs with similar priority may be linked to the same LCG., which for example may allow a gNB to differentiate between the volume of high priority data and the volume of lower priority data. Conditions, events, and/or rules may be associated with each other. For example, conditions, events, and rules may be interchangeable.

Collected data for the training of an AI/ML model may have different requirements and/or characteristics than normal user plane (UP) traffic. For example, a WTRU may be configured to log measurements related to (e.g., some) AI/ML model/functionality. Additionally, or alternatively, the WTRU may have a certain amount of buffer capability to collect such measurements (e.g., related to AI/ML model/functionality). Data may be collected from many WTRUs and/or model training may be done at a training server. It (e.g., therefore) may not be urgent to send collected data on a real time basis. The model may be trained at a function/entity within the operator's network and/or an OTT server that is outside the operator's network (e.g., is owned by the WTRU vendor or a third party, etc.) for example. The data may (e.g., therefore) not have a given/fixed bit rate, priority, and/or latency requirements, for example as for a typical DRB.

If the buffer is available for logging (e.g., such) data is full for example, collected data may be sent immediately. For example, the WTRU may (e.g., otherwise) stop/pause the data collection and/or must flush older measurements for newer ones. This may not be desirable, for example as an older measurement may not be less valuable. For example measurements may not be intended to be used for real time actions. Some scheduling/rate control mechanisms may be defined to handle the transmission of DRBs/SRBs and/or may not be sufficient/appropriate for sending of data collected for the training of an AI/ML model.

Systems and methods herein may enable dynamic BSR/SR triggering that may enable (e.g., optimal) transmission of collected data for AI/ML model training, for example without compromising transmission of (e.g., other) UP traffic. There may be conditional availability of data and/or data volume concerning logged/collected data, for example to lower layers.

A WTRU may be configured with a bearer for sending logged/collected data. The WTRU may be configured to make the collected data available to a lower layer, for example conditionally. The WTRU may be configured to include the collected data in the data volume calculations, for example conditionally. For example, the WTRU may make the collected data available to a lower layer and/or include the collected data in the data volume calculations based on a condition. Example conditions may include a network condition and/or a WTRU condition. An example network condition may include radio signal level. Example WTRU conditions may include current level of buffer occupancy associated with the data collection, an activity level of (e.g., other) bearers, reception of a request to report collected data from network and/or OTT server, and/or a time since data collection started, etc.

A WTRU may receive configuration information, for example including a data collection configuration. The configuration information may include data to be collected (e.g., measurement configuration), a configuration related to an associated bearer (e.g., DRB, low priority SRB, etc.) to be used for reporting the collected data, a first set of conditions/events, and/or a second set of conditions/events. The first set of conditions/events may be related to the performing data logging/collection, for example including starting conditions, stopping conditions, and/or logging conditions, etc. The second set of conditions/events may be for making the collected data available to lower layers and/or making the collected data considered in data volume calculations.

Example conditions/events may include a volume of collected data, WTRU battery/power level, a time remaining/elapsed (e.g., since data collection started, and/or a certain time before a deadline to send the collected data, etc.), receiving a data collection reporting request (e.g., from the network, from OTT/application server), a congestion level (e.g., based on indication from the network), an activity level/buffer level of (e.g., other) DRBs, one or more serving cell radio conditions, and/or on recovery from failure (e.g., beam recovery, and/or radio link failure recovery, etc.).

The WTRU may perform the data collection/logging, for example according to the first set of conditions/events. The WTRU may transfer the collected data, for example to the associated bearer. The WTRU may monitor the second set of conditions/events. The WTRU may make the collected data available to lower layers and/or include them in the data volume calculation, for example upon determining that the second set of conditions/events are fulfilled. The WTRU may stop/pause making the collected data available to lower layers and/or not include the collected data in the data volume calculation, for example upon determining that the second set of conditions/events are not fulfilled. Determining that the set of conditions/events are not fulfilled may include restricting access to the (e.g., collected) data. The WTRU may restrict access to the data, for example if the WTRU determines that the set of conditions/events is not satisfied (e.g., fulfilled). Fulfilled and satisfied may be used interchangeable herein.

There may be conditional triggering of BSR/SR, for example due to availability/arrival of collected data. A WTRU may be configured with a bearer for sending logged/collected data. The WTRU may be configured to modify the BSR/SR triggering due to the collected data, for example based on set of conditions/events. Example conditions may include a network condition and/or a WTRU condition. An example network condition may include radio signal level. Example WTRU conditions may include a current level of buffer occupancy associated with the data collection, an activity level of (e.g., other) bearers, and/or reception of a request to report collected data from network and/or OTT server, etc.

The WTRU may receive configuration information, for example including a data collection configuration (e.g., RRC message). The configuration information may include data to be collected (e.g., measurement configuration), a configuration related to an associated bearer (e.g., DRB, low priority SRB, etc.) to be used for reporting the collected data, a first set of conditions/events, and/or a second set of conditions/events. The first set of conditions/events may be related to the performing data logging/collection, for example including starting conditions, stopping conditions, and/or logging conditions, etc. The second set of conditions/events may be for modifying the BSR/SR triggering behavior, for example due to the collected data.

Example conditions/events may include a volume of collected data, WTRU battery/power level, receiving a data collection reporting request (e.g., from the network, from OOT/application server), a congestion level (e.g., based on indication from the network), an activity level/buffer level of (e.g., other) DRBs, one or more serving cell radio conditions, and/or on recovery from failure (e.g., beam recovery, and/or radio link failure recovery, etc.).

The WTRU may perform the data collection/logging, for example according to the first set of conditions/events. The WTRU may construct the one or more PDCP service data units (SDUs) for the collected/logged data and/or transmit the one or more PDCP SDUs to the PDCP entity of the associated bearer. The WTRU may monitor the second set of conditions/events. The WTRU may transmit a BSR/SR to the network, receive a UL grant, and/or transmit (e.g., all or a portion of) pending data using the UL grant, for example upon the fulfillment of the conditions/events. The WTRU may transmit the BSR/SR to the network indicating there is a collected data pending to be transmitted.

Systems and methods may provide consistency between training and inference. A (e.g., given) AI/ML model may be trained under (e.g., certain) WTRU and/or network side conditions. For example, a WTRU side condition may include a speed of the WTRU. Network side conditions may be related to network configurations/settings, for example that the WTRU may not be aware and/or may impact the performance of the model. For example, an RLF prediction model may perform differently if the model was trained when the network was using a certain antenna pattern, beam pattern, and/or power level, etc. There may be aspects related to network load, that for example may impact model performance.

The WTRU may not need and/or have details of the network side conditions. For example, the network may not provide (e.g., some) details. The network may hide these details, for example by signaling to the WTRU one or more associated ID(s). For example, when data is being collected for training a model, tagging may be performed. The tagging may indicate under which network side conditions the model is being trained. Before a WTRU is being configured to perform an operation based on an AI/ML model for example (e.g., measurement prediction), the WTRU may be configured to check the consistency between condition. For example the WTRU may be configured to check the consistency between the conditions under which the AI/ML model is trained and current conditions (e.g., current WTRU conditions, and/or current associated ID(s) signaled by the network indicating current network conditions/settings, etc.).

The term life cycle management (LCM) may be used to describe (e.g., overall) management aspects of AI/ML models. Example management aspects of AI/ML models may include model training, functionality/model identification, model delivery/transfer, model inference operation, functionality/model monitoring, model update, WTRU capability, data collection (for model training, for monitoring, for inference, etc.), and/or functionality/model selection, activation, deactivation, switching, and/or fallback operation. Functionality/model selection, activation, deactivation, switching, and/or fallback operation may include a decision by the network (e.g., either network initiated or WTRU-initiated and requested to the network), and/or a decision by the WTRU (e.g., event-triggered as configured by the network, WTRU's decision reported to the network, and/or WTRU-autonomous either with WTRU's decision reported to the network or without it).

LCM may be functionality-based LCM and/or model-ID based LCM. In functionality-based LCM for example, a network may indicate activation/deactivation/fallback/switching of AI/ML functionality. For example the network may indicate activation/deactivation/fallback/switching of AI/ML functionality via 3GPP signaling (e.g., RRC, MAC-CE, DCI). Models may not be identified at the network in some examples. A WTRU may perform model-level LCM, for example if the models are not identified at the network. The WTRU may have one AI/ML model for a functionality, or the WTRU may have multiple AI/ML models for the functionality.

In model-ID-based LCM for example, models may be identified at the network. The network/WTRU may activate/deactivate/select/switch individual AI/ML models, for example via model ID. In the functionality based LCM for example, the WTRU may choose the AI/ML model to use for a certain functionality. The network may determine for which functionalities the WTRU may use AI/ML based operation. The WTRU may (e.g., then) determine the AI/ML model to use, for example based on the network determination of for which functionalities the WTRU may use AI/ML based operation.

In the model-ID based LCM for example, the network may (e.g., explicitly) control which (e.g., particular) model may be used for a given AI/ML functionality. For example, the WTRU may provide details of AI/ML models and/or capabilities. The network may determine which model to activate for a particular functionality.

Systems and methods herein may be applicable to (e.g., both) model-ID based and/or functionality-based LCM. Systems and methods may be related to how the WTRU may determine whether the WTRU has a model that is applicable for the indicated associated ID(s). For example for functionality-based LCM, the WTRU may be configured/requested to determine if a given functionality is valid/applicable. The WTRU may determine if the (e.g., given) functionality is valid/applicable determination among (e.g., all) the models that the WTRU has. The WTRU may determine that the functionality is applicable, for example if at least one of the models is applicable. For model-ID based LCM for example, the WTRU may be configured/requested by the network to determine whether a particular model is applicable or not. An associated identifier (ID) may be specific to a given functionality and/or the ID may be applicable/common to more than one and/or functionalities.

The WTRU may support several AI/ML models for a given functionality, for example with different prediction time horizons, prediction confidence levels, processing requirements, and/or trained under/for operation in different frequencies/cells/location/times of day, etc.). An (e.g., given) AI/ML model for a certain functionality may operate in different modes (e.g., with different levels of prediction confidence levels at different prediction time horizons, at different locations, frequencies, and/or WTRU mobility pattern/speed, etc.). The AI/ML models may be available at the WTRU already trained, or the WTRU may be provided with an untrained AI/ML model. The WTRU may train a model, for example an untrained model. The WTRU may further train a model that has already been trained.

The AI/ML model may be available at the WTRU already trained, and the WTRU may be enabled/configured to perform further training (e.g., for different conditions such as frequencies/cells/location/times of day, for the same conditions as the initial training but for increasing the level of confidence and/or the prediction time horizon, and/or for different WTRU speeds, etc.). The AI/ML model may be available at the WTRU but not trained at all or only trained for certain WTRU/network conditions. The WTRU may be configured to train the model (e.g. for the conditions that it is not trained for).

In some examples, the WTRU may utilize some configurations/inputs for performing the inference using an AI/ML model. For example for radio signal level prediction, the WTRU may be configured with a certain number of beams/cells to measure to determine the prediction. In some examples, the WTRU may communicate a requested (e.g., required) configuration/input as part of the capability information. Additionally, or alternatively, the WTRU may communication a requested (e.g., required) configuration/input to the network after a capability request (e.g., based on explicit network request, if the WTRU gets configured to do AI/ML based measurement predictions, and/or the WTRU has determined that it is lacking the required configuration/input, etc.).

A WTRU may be configured to collect data, that for example may be used for training of an AI/ML model. In some examples the WTRU may not be configured to perform AI/ML based operations. The data to be collected may be used for a training a network sided model, a WTRU sided model, or the WTRU and/or network sides of a two-sided model (e.g., a CSI compression model where there is an encoder model at the WTRU and a corresponding decoder model on the network side).

Systems and methods herein may be applicable to (e.g., any kind of) data collection that is performed for other purposes than a training of an AI/ML model, for example sensing and/or application layer performance monitoring. Systems and methods herein may be applicable to data not related to data collection, for example applications that may have similar needs to data collection (e.g., by default having no latency and/or bit rate requirements but with the requirements changing based on some conditions). Systems and methods herein may be applicable to a (e.g., any) data collection architecture, for example regardless of the destination server for the data (e.g., within the RAN, in the CN, within the operator's network outside the RAN/CN, and/or outside the operator's network). The term data collection bearer may be used to describe a (e.g., any) bearer, for example DRB, SRB, a new bearer that is associated with a (e.g., certain) data collection process. The terms data collection bearer and data collection logical channel may be used interchangeably. The terms functionality and procedure may be used interchangeably. The terms data, measurement(s), report(s), and/or result(s) may be used interchangeably. The terms logging and collecting may be used interchangeably. Other associated terms such as like logged data and collected data, etc. may be used interchangeably. The terms indication, information, and/or message may be used interchangeably.

In some examples a logical channel may have priority values from 1 to 16, where 1 may be the highest priority level and 16 may be the lowest priority level. Raising the priority level as herein may refer to decreasing the priority value. Lowering the priority level as herein may refer to increasing the priority value.

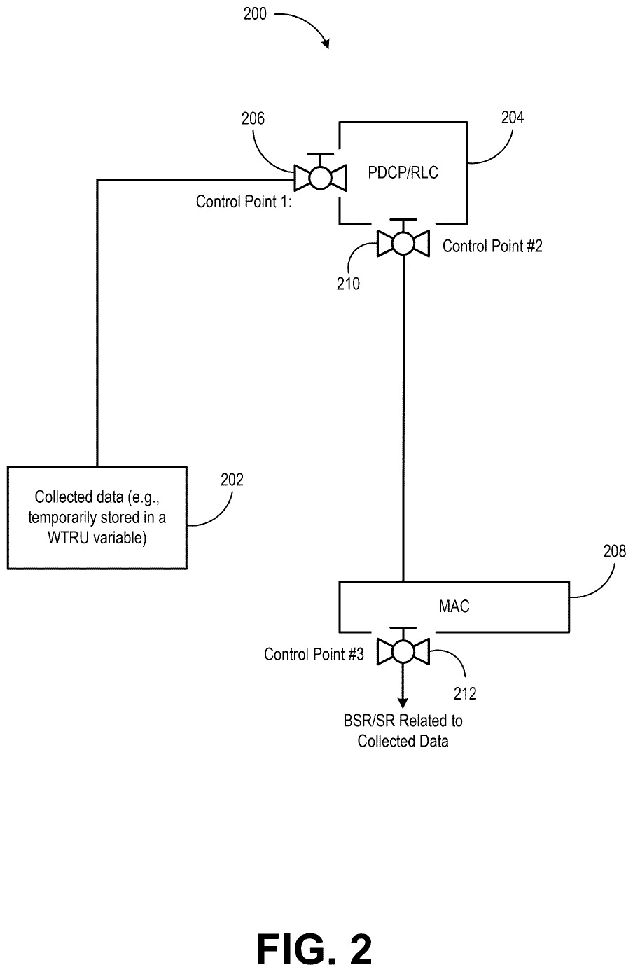

FIG. 2 is an example diagram of a system architecture 200. For example the system architecture may be included in a WTRU. The WTRU may collect data at 202. The WTRU may additionally, or alternatively, store the collected data, for example in a WTRU variable (e.g., buffer). The WTRU may make the collected data available to a PDCP/RLC at 204. For example, the WTRU may control a control point 206 such that the collected data is available to the PDCP/RLC. For example, the WTRU may make the collected data available (e.g., by controlling the control point 206) to a PDCP/RLC by controlling if and/or how much of the collected data is to be made available to the PDCP/RLC of the bearer associated with data collection (e.g., with an enhancement). The WTRU making (e.g., collected) data available may be referred to herein as allowing access.

The WTRU may make the collected data available to a MAC at 208. For example, the WTRU may control a control point 210 such that the collected data is available to the MAC. For example, the WTRU may make the collected data available (e.g., by controlling the control point 210) to a MAC by controlling how much data is made available to lower layer (e.g., MAC) and/or how much data is indicated as available to lower layers (e.g., MAC) during data volume calculation. The WTRU may send the BSR/SR, for example to a network. The WTRU may send the BSR/SR (e.g., to the network), for example by controlling a control point 212. For example, the WTRU may transmit the collected data (e.g., by controlling the control point 212) to the network based on BSR/SR triggering (e.g., at the MAC level) (e.g., conditionally disabling/enabling BSR/SR triggering due collected data, and/or conditionally modifying the priority of the data collection logical channels, etc.).

BSR/SR triggering, for example due to the collected data, may be controlled directly and/or indirectly. Indirect control may refer to legacy BSR/SR triggering mechanisms and one or more of controlling if and/or how much of the collected data is to be made available to the PDCP/RLC (e.g., with an enhancement) and/or controlling how much data is made available to lower layer (e.g., MAC) and/or how much data is indicated as available to lower layers (e.g., MAC) during data volume calculation. Direct control may refer to controlling based on the BSR/SR triggering (e.g., at the MAC level), for example with an enhancement (e.g., conditionally disabling/enabling BSR/SR triggering due collected data, and/or conditionally modifying the priority of the data collection logical channels, etc.).

The term bearer suspension may refer to the PDCP pausing sending of PDCP packets, for example to lower layers. The term bearer resumption may refer to the PDCP resuming sending PDCP packets, for example to lower layers.

Systems and methods may include a data collection configuration. The data collection configuration may be included in configuration information. The WTRU may receive the data collection configuration (e.g., configuration information) from the network (e.g., gNB, LMF, CN, OAM, NWDAF, and/or any Network Function (NF) within the operator's network) and/or from outside the network (e.g., OTT server). The WTRU may request a measurement configuration from the network, for example if the data collection configuration is from outside of the network. The WTRU may request the measurement configuration from the network to (e.g., be configured to) gather the required information.

The WTRU may receive a data collection configuration (e.g., configuration information). The data collection configuration may include one or more of that may include one or more of information/measurement to be logged, (e.g., additional) information the WTRU may include in the measurements (e.g., timestamps, location/cell information, associated IDs, and/or WTRU side conditions, etc.), a logging periodicity, logging events/conditions (e.g., radio conditions that may be fulfilled for the logging to be performed, times of the day for the logging to be performed, and/or areas/cells where the logging is to be performed, etc.), information regarding when logging is to be started (e.g., immediately, after a certain time delay, at an absolute time in the future, when WTRU goes into certain area/cell, etc.), information regarding when logging is to be stopped/paused (e.g., when the amount of collected data reaches a certain buffer threshold, when a certain number of samples have been collected, etc.), information regarding when collected data may or may not be reported to the network (e.g., specific time window during which collected data may be sent or may not be sent, and/or may be done dynamically via an explicit indication to start/stop sending the collected data, as discussed herein), and/or information related to the data destination (e.g., RAN, CN, OAM, another NF, OTT server, etc.), etc.

A data collection configuration may be referred to as a data collection process herein. The data collection configuration may be related to a certain higher usage level (e.g., sensing, AI/ML operation, etc.) and/or may be at a detailed granularity level for example different data collection configurations for the training of models for different AI/ML functionalities and/or sub functionalities (e.g., one for CSI compression, one for temporal beam/cell measurement prediction, one for spatial beam/cell measurement prediction, and/or one for positioning, etc.)

Multiple data collection configurations may be provided to the WTRU separately. A (e.g., each) data configuration may configure different measurements/information to be gathered and/or may have different detailed information/parameters regarding the given data collection configuration. Additionally, or alternatively, all or a subset of the configuration may share some of the configuration elements (e.g., may have a common periodicity, similar additional information to add to the measurements, and/or stopping/reporting conditions, etc.) and/or may have separate configuration elements (e.g., the measurement to be performed, events for logging, and/or buffer level thresholds, etc.).

There may be an association of data collection bearers and logical channels. The WTRU may receive a configuration regarding how the collected data based on the received configuration is to be mapped to an associated bearer and logical channel. The associated bearer may be referred to as data collection bearer herein. The associated logical channel may be referred to as data collection logical channel herein.

The mapping may be according to one or more of one data collection bearer/logical channel for all data collection configurations, separate data collection bearer/logical channel for each data collection configuration, separate data collection bearer/logical channel for different types of data collection (e.g., one for data collection for AI/ML model training, and/or one for data collection for sensing, etc.), separate data collection bearers/logical channels for different data termination points/destinations (e.g., one for data destined at a RAN entity/network function, one for data destined at CN entity/network function, one for data to be collected at the OAM, and/or one for data to be collected at an OTT server outside the operator's network, etc.), and/or multiple bearers/logical channels.

A data collection configuration may be mapped to a data radio bearer (DRB) and/or a signaling radio bearer (SRB). The terms data collection bearer, collected data bearer, data collection logical channel, and/or logical channel for data collection may be used interchangeably. Data type as herein may refer to system data, sensing data, positioning data, model transfer data, computing/operational data, measurement data, and/or (e.g., more generally) data plane data. In some examples, a separate bearer may be set up for each data type.

There may be conversion of collected data samples into PDCP SDUs. In an NR protocol stack for example, for DRBs a PDCP may receive IP packets (e.g., PDCP SDUs). If the collected data is to be sent via a DRB for example, (e.g., then) the collected data (e.g., from a WTRU variable) may be mapped into a PDCP SDU. Mapping of the collected data into a PDCP SDU may include a (e.g., each) sample of logged data converted to one PDCP SDU, a certain (e.g., configured value) number of samples multiplexed into one PDCP SDU, and/or (e.g., all) samples that may fit into a maximum size of a PDCP SDU (e.g., 9000 bytes or some other maximum value defined for data collection bearers) grouped together into one PDCP SDU and/or any leftover samples fit into a smaller PDCP SDU (e.g., the WTRU will minimize the total number of PDCP SDUs to be sent).

There may be generalization to (e.g., other) protocol stacks/architectures. Systems and methods herein may utilize a NR protocol architecture for single connectivity, for example with no duplication or split bearer operation. For example, for each bearer there may be one PDCP entity, one RLC entity, and/or one logical channel. A WTRU may have a single MAC entity. However, systems and methods herein may additionally, or alternatively, utilize other protocol architectures and/or bearer to logical mappings (e.g., in 6G). For example, systems and methods may be utilized for a bearer-less operation (e.g., each packet containing header information that may be used by the MAC for LCP operation), a many-to-many mapping between bearers and logical channels (e.g., one bearer mapped to multiple logical channels even though there is no legacy split bearer or duplication being performed, and/or one logical channel mapped to multiple bearers, etc.), a UP protocol stack that may not include the RLC (e.g., PDCP sitting directly above MAC), and/or a separate data plane protocol stack (e.g., that may have its own logical MAC entity). For example (e.g., all) the logical channels for data collection may be associated with the separate data plane protocol stack.

Systems and methods herein may include enhancements for the UP plane, the DP plane and associated bearers/logical channels, enhancements for the UP plane and DP plane with (e.g., similar) conditions/thresholds and/or different conditions/thresholds associated for the UP and DP planes. Systems and methods may control data and/or data volume available to lower layers and/or enable/disable BSR/SR triggering. The WTRU may be configured to suspend a data collection bearer and/or disable the triggering a BSR/SR due to a logical channel associated with the bearer, for example if the volume of the collected data that is pending to be sent is below a certain threshold. For example there may be a (e.g., separate) threshold for a (e.g., each) data collection bearer/logical channel (e.g., if different data collection processes are happening at the same time, and/or for collecting data for the training of models for different AI/ML functionalities). There may be one threshold that is associated with a subset of the data collection bearers/processes in some examples. In other examples there may be one threshold that is associated with all data collection bearers.

The WTRU may be configured to resume a suspended data collection bearer and/or enable the triggering a BSR/due to a logical channel associated with the bearer, for example if the volume of the collected data that is pending to be sent is above a certain threshold. There may be a (e.g., separate) threshold for a (e.g., each) data collection bearer (e.g., if different data collection processes are happening at the same time, and/or for collecting data for the training of models for different AI/ML functionalities. There may be one threshold that is associated with a subset of the data collection bearers/processes in some examples. In other examples there may be one threshold that is associated with all data collection bearers.

The data volume threshold may be an absolute threshold (e.g., in terms of bits or number of collected samples) or a relative threshold (e.g., as a percentage of the maximum buffer level allocated for that data collection process, and/or percentage of the maximum buffer level allocated for all data collection, etc.).

In addition or alternative to a buffer occupancy threshold, a remaining buffer level threshold may be used, for example to control the suspension/resumption of the bearers and/or the enabling/disabling of the BSR/SR. The WTRU may be configured to suspend a bearer and/or disable the triggering a BSR/SR due to a collected data associated with the bearer (e.g., as herein), for example if the WTRU battery level falls a certain (e.g., percentage) threshold. There may be a (e.g., separate) threshold for a (e.g., each) data collection bearer (e.g., if different data collection processes are happening at the same time, and/or for collecting data for the training of models for different AI/ML functionalities). There may be one threshold associated with a subset of the data collection bearers/processes in some examples. In other examples there may be one threshold associated with all data collection bearers.

The WTRU may be configured to resume a suspended bearer and/or enable the triggering of a BSR/SR due to a logical channel associated with the bearer (e.g., as herein), for example if the WTRU battery level exceeds a certain (e.g., percentage) threshold. There may be a (e.g., separate) threshold for a (e.g., each) data collection bearer (e.g., if different data collection processes are happening at the same time, and/or for collecting data for the training of models for different AI/ML functionalities). There may be one threshold associated with a subset of the data collection bearers/processes in some examples. In other examples there may be one threshold associated with all data collection bearers.

In addition or alternative to buffer levels and/or WTRU battery/power levels discussed herein, several (e.g., other) parameters may be utilized to determine to suspend/resume a bearer and/or to enable/disable BSR/SR triggering based on collected data. Example (e.g., other) parameters may include a time remaining and/or an elapsed time related threshold, a time since the data collection report request has been received at the WTRU and/or an elapsed time related threshold, a congestion level, an activity level/buffer level of (e.g., other) DRBs, one or more serving cell radio conditions, and/or occurrence of one or more events.

A parameter may include a time remaining and/or elapsed time related thresholds. The time remaining and/or elapsed time related thresholds may be related to an amount of time since data collection started, a time since the earliest collected data sample that is pending to be transmitted, and/or a relative/absolute time difference from a specified deadline (e.g., provided as part of the data collection configuration), etc. For example, a WTRU may be configured to suspend the bearers until the remaining time from a pre-configured deadline to send the collected data is below a certain threshold, etc.

A parameter may include a time since the data collection report request has been received at the WTRU and/or elapsed time related thresholds. A WTRU may be configured to resume the bearer and/or enable the BSR/SR trigger for the associated logical channel, for example for a certain duration after the reception of the data collection request. The WTRU may be configured to suspend the bearer or disable the BSR/SR, for example after the time duration has elapsed.

A parameter may include a congestion level, for example indicated from the network. The network may indicate the congestion level. The WTRU may suspend the data collection bearer(s) and/or disable BSR/SR triggering due to the associated logical channel(s), for example if congestion level is above a certain threshold. The WTRU may resume the bearers and/or enable BSR/SR triggering, for example if congestion level falls below a certain threshold, etc.

A parameter may include an activity level/buffer level of other DRBs. The activity level/buffer level of the other DRBs may be related to the buffer and/or activity level of other UP DRBs. For example the WTRU may suspend the data collection bearer(s), for example if the outstanding buffer level of other UP DRBs is above a certain threshold. The WTRU may resume the data collection bearer(s), for example if the outstanding buffer level of other UP DRBs is below a certain threshold, etc.

A parameter may include one or more serving cell radio conditions. The WTRU may be configured to suspend the data collection bearer(s) and/or disable the BSR/SR triggering due to the associated logical channels, for example if the serving cell radio signal level is below a certain threshold. The WTRU may be configured to resume the data collection bearer(s) and/or enable the BSR/SR triggering due to the associated logical channels, for example if the serving cell radio signal level is above a certain threshold, etc.

A parameter may include occurrence of one or more events. For example, the WTRU may be configured to disable/enable the BSR/SR triggering due to data collection logical channels (e.g., for a certain time duration), for example after the occurrence of an event (e.g., detection of radio link problem, recovery from radio link problem, detection of radio link failure, recovery from RLF via re-establishment, and/or recovery from RLF via CHO/LTM, etc.). The WTRU may be configured to suspend/resume the data collection bearers (e.g., for a certain time duration), for example after the occurrence of an event (e.g., detection of radio link problem, recovery from radio link problem, detection of radio link failure, recovery from RLF via re-establishment, and/or recovery from RLF via CHO/LTM, etc.).

A parameter may include a network energy saving (NES) state (e.g., explicitly indicated by the network or detected by the WTRU due to reduced transmission activity, and/or cell DTX, etc.), a WTRU power saving state (e.g., while C-DRX is activated, and/or during the non-active periods of C-DRX and/or cell DTX, etc), a WTRU CPU load and/or processing state, a time of day condition, and/or a PBR and/or Bj value (e.g., dynamic bucket size). The PBR value and/or Bj value may be associated with a data collection bearer being larger than or lower a threshold. For example the WTRU may report/trigger BSR if PBR is large enough to transmit data collection bearer SDUs (e.g., at least one) without segmentation. The WTRU may omit reporting buffer status for data collection bearers that have not accumulated enough PBR/Bj to transmit at least one SDU (e.g. packet) without segmentation.

The WTRU may be configured to resume suspended data collection bearer(s) and/or enable the triggering of BSR/SR due to a data collection logical channel, for example upon receiving a data collection report request (e.g., from the radio access network, from the core network, any other network function/entity, or an external server/entity outside the operator's network, e.g., if the collected data is to be sent to that external entity). For example the data collection report request may be for all data collection bearers at once, for a particular data collection bearer, or a certain subset of the bearers. The resumption of the bearer and/or the enabling/disabling of the BSR/SR may affect the concerned bearer(s) in some examples.

The WTRU may be configured to suspend a data collection bearer or disable BSR/SR triggering due to data of that bearer, for example that has been resumed due to any condition (e.g., as herein). For example, the WTRU may suspend a data collection bearer or disable BSR/SR triggering due to data of that bearer a certain configured duration after resuming the bearer and/or enabling of the BSR/SR triggering. The WTRU may additionally or alternatively be configured with buffer volume related configurations. A buffer volume related configuration may be included in configuration information. For example the WTRU may suspend the bearer if the configured time duration has passed and/or based on the outstanding buffer level (e.g., for that bearer or all data collection bearers, and/or has decreased by a certain absolute/percentage amount).

The WTRU may be configured to resume a data collection bearer or enable BSR/SR triggering due to data of the associated logical channel, for example that has been suspended due to any condition (e.g., as herein). For example the WTRU may resume a data collection bearer or enable BSR/SR triggering a certain configured duration after the suspension of the bearer and/or disabling of the BSR/SR triggering. The WTRU may additionally or alternatively be configured with buffer volume related configurations. For example the WTRU may resume the bearer if the configured time duration has passed and/or based on the outstanding buffer level (e.g., for that bearer or all data collection bearers, and/or has increased by a certain absolute/percentage amount).

For (e.g., some of) parameter to be monitored, the threshold for suspending a bearer and/or disabling BSR/SR triggering may be the same or different from a threshold for resuming a bearer and/or enabling BSR/SR triggering. The WTRU may be configured with a time trigger (TTT), for example associated with a (e.g., any) threshold (e.g., as herein). The condition (e.g., data collection volume threshold, and/or WTRU battery level, etc.) may satisfy the associated threshold for the duration, for example before the WTRU may apply the action (e.g., to suspend the bearer, to resume the bearer, enable the BSR/SR triggering, and/or disable the BSR/SR triggering, etc.). The TTT value may be the same for both the suspension and resuming and/or disabling and enabling the BSR/SR. In other examples different TTT values may be assigned for both the suspension and resuming and/or disabling and enabling the BSR/SR. Additionally, or alternatively, TTT values may be assigned for different parameters to be checked (e.g., one TTT related to data volume thresholds, and/or another TTT related to WTRU battery power, etc.).

Systems and methods may control the transmission of PDCP SDUs to the data collection PDCP entity. The WTRU may be configured to store the collected data (e.g., temporarily) in a WTRU variable, for example before pushing the data to the PDCP of the bearer associated with the data collection. There may be several WTRU variables associated with different data collection processes (e.g., data collection for training of AI/ML models for different functionalities, and/or data collection for sensing, etc.). A (e.g., each) variable may have associated (e.g., different) configuration parameters (e.g., maximum size limit, maximum time limit to store the data, etc.).

The WTRU may be configured to transfer the stored data from the WTRU variable to the PDCP of the bearer associated with the WTRU variable, for example upon the fulfillment of a (e.g., some) condition(s) (e.g., one or more of the conditions discussed herein, when the maximum size limit is reached, and/or when a maximum time limit is reached, etc.). The WTRU may be configured to delete the data it has transferred to the PDCP of the associated bearer. The WTRU may be configured to transfer a certain amount of data (e.g., periodically, every x samples or every x bits, etc.) to the associated PDCP, for example such that the amount of data remaining in the WTRU variable does not surpass a certain maximum level.

The WTRU may be configured to transfer a certain sample of data, a certain number of samples of data, and/or a certain number of bits of data, for example depending on the age of the data collected. For example, the WTRU may transfer the data samples that are older than a certain configured time threshold, etc.

Systems and methods herein may include suspending/resuming of the bearers and/or enabling/disabling of BSR/SR. However, systems and methods for suspending/resuming of the bearers may be applicable to controlling when the collected data is transferred to the PDCP entity (e.g., as discussed herein).

WTRU behavior during suspension and/or resumption of a data collection bearer are discussed herein. DRBs may be suspended in some scenarios, for example failure (e.g., RLF, MCG/SCG failure, and/or SCG deactivation, etc.), mobility, and/or during connection release to INACTIVE, etc. When a PDCP is suspended for example, the PDCP may set TX_NEXT to the initial value and/or discard all stored PDCP PDUs. For example the transmitting PDCP entity may set TX_NEXT to the initial value and/or discard all stored PDCP PDUs. The WTRU may restore the connection in another cell (e.g., after the RLF, after mobility) and/or acquire new security context/configuration. Therefore transmitting the pending PDCP PDUs (e.g., that were encrypted and/or integrity protected with the previous security configuration) may be unnecessary and/or may cause abnormal behavior at the receiver (e.g., as the security context maybe changed after failure and/or mobility).

The suspension of the bearer may be a way to control collected data from reaching lower layers and/or triggering a BSR/SR. Therefore discarding the stored PDCP PDUs in and/or resetting the TX_NEXT state variable (e.g., which is the COUNT value of the next PDCP SDU to be transmitted) to the initial value may be unnecessary. The PDCP entity behavior during bearer suspension may (e.g., therefore) be modified. For PDCP entities not associated for a data collection purpose and/or when upper layers request a PDCP entity suspend, the transmitting PDCP entity may set TX_NEXT to the initial value and/or discard all stored PDCP PDUs.

The WTRU may be configured with (e.g., different) behaviors for the suspension of a data collection bearer, for example in addition or alternative to maintaining the PDCP PDUs and the TX_NEXT. For example, the suspension of the bearers in NR during failure may be temporary (e.g., until recovery, and/or mobility finalization, etc.). Suspension of the data collection bearers may be for a long duration (e.g., until the conditions for the resumption of the bearer are fulfilled, and/or as discussed herein). Therefore some handling of discard timers for PDCP SDUs may result in packets being discarded prematurely while the bearer is suspended. This may be avoided, for example by setting the discard timer value for the PDCP of the data collection bearer to infinity. Setting the discard timer value for the PDCP of the data collection bearer to infinity may lead to PDCP buffer overflow and/or (e.g., consequently) data loss.

The WTRU may suspend the discard timers of the PDCP SDUs of the data collection bearer, for example while the bearer is suspended. The WTRU may (e.g., then) resume the discard timers of the PDCP SDUs of the data collection bear when the bearer is resumed. Additionally, or alternatively, the WTRU may restart the discard timers (e.g., completely) when the bearer is resumed.

If there is a discard and/or storage timer associated with the whole data collection process/buffer for example, the discard and/or storage timer may be utilized instead of or in addition to the discard timer of individual discard timers of the PDCP SDUs of the data collection bearer. A PDCP SDU may be discarded even if its discard timer has not expired, for example if the discard/storage timer for the data collection expires. A PDCP SDU may not be discarded even if its discard timer has expired, for example if the discard/storage timer for the data collection has not expired.

In RLC once a bearer is suspended for example, the WTRU may (e.g., continue to) recover and/or reassemble retransmissions of segments already transmitted. The transmission of new data SDUs may be suspended, for example when the bearer is suspended (e.g., in RLC). Additionally, or alternatively, the WTRU may discard packets that have not been acknowledged, for example when the bearer is suspended (e.g. for RLC AM, or RLC UM for segmented SDUs). The RLC entity may provide a NACK and/or trigger a status report, for example when a bearer is suspended (e.g., if a pending SDU is discarded).

In MAC once a bearer is suspended for example, the MAC entity may multiplex and/or transmit data that has already been provided/made available to MAC. Additionally, or alternatively, the WTRU MAC may multiplex the data with the lowest priority once the associated bearer is suspended. The WTRU may allocate resources to the bearer, for example in the second round of scheduling in LCP. For a suspended bearer for example, the MAC entity may not trigger MAC CEs related to reporting or transmission of the associated data.

There may be data volume calculation. In PDCP, data volume calculation may be done by considering PDCP data volume. For the purpose of MAC buffer status reporting for example, the transmitting PDCP entity may consider PDCP data volume. Example PDCP volume may include the PDCP SDUs for which no PDCP Data PDUs have been constructed, the PDCP Data PDUs that have not been submitted to lower layers, the PDCP control PDUs, and/or the PDCP SDUs to be retransmitted (e.g., for AM DRBs)

In RLC, the data volume calculation may be done by considering RLC data volume. For the purpose of MAC buffer status reporting for example, the WTRU may consider RLC data volume. Example RLC data volume may include RLC SDUs and/or RLC SDU segments that have not yet been included in an RLC data PDU, RLC data PDUs that are pending for initial transmission, and/or RLC data PDUs that are pending for retransmission (e.g., RLC AM).

A WTRU may be configured to not consider the pending PDCP and/or RLC packets associated with data collection (e.g., PDCP SDUs/PDUs, RLC SDUs and segments, and/or RLC data PDUs, etc.) in the data volume calculation, for example based on one or more conditions discussed herein and/or when the bearer is suspended. The PDCP of the data collection bearer may be configured to consider the pending PDCP SDUs in the data volume calculation (e.g., based on the one or more conditions discussed herein, and/or when the bearer is paused, etc.). The PDCP of the data collection bearer may be configured to consider the pending PDCP PDUs in the data volume calculation (e.g., based on the one or more conditions discussed above, when the bearer is paused, etc.).

The RLC of the data collection bearer may be configured to consider the pending RLC SDUs and/or RLC SDU segments in the data volume calculation (e.g., based on the one or more conditions discussed above, and/or when the bearer is paused, etc.). The RLC of the data collection bearer may be configured to consider the pending RLC SDUs and/or RLC SDU segments in the data volume calculation (e.g., based on the one or more conditions discussed above, and/or when the bearer is paused, etc.). In data volume calculations (e.g., for one or more logical channels for data collection) for example, the volume may include the amount of data that is collected/logged but not transferred to PDCP (e.g., still in the WTRU variable in one example modelling described herein), the amount of collected data that is buffered at PDCP level, and/or the amount of collected data that is buffered at RLC level, etc.

Systems and methods include dynamic/conditional changing of the priority of data collection logical channels. Systems and methods may control whether the BSR/SR may be triggered based on data collection logical channels, for example depending on a number of conditions/thresholds (e.g., indirectly by suspending the bearer and/or modifying the PDCP/RLC data volume calculations, and/or directly by enabling/disabling the BSR/SR triggering for those channels). Additionally, or alternatively, BSR/SR triggering may be controlled by modifying the logical channel priority of the data collection logical channels.

There may be a conditional change of the priority of data collection logical channels. Conditions (e.g., as herein) to control the suspension/resumption of a data collection bearer and/or the enabling/disabling of the BSR/SR triggering due to a data collection logical channel may be considered for modifying the priority of the data collection logical channel. Modifying the priority of the data collection logical channel may modify the BSR/SR behavior.

Conditions (e.g., herein) for suspending/resuming bearers may be data volume related. If the volume of collected data pending to be transmitted exceeds a certain threshold (e.g., absolute threshold, and/or a percentage of the maximum buffer allocated for the data collection, etc.) for example, the WTRU may increase the priority (e.g., set to a higher configured absolute priority level, and/or the priority level raised by a configured delta level over the default or the current priority level, etc.). If the volume of collected data pending to be transmitted becomes lower than a certain threshold (e.g., absolute threshold, a percentage of the maximum buffer allocated for the data collection, and/or a percentage of the buffer level when the priority was increased previously, etc.) for example, the WTRU may decrease the priority (e.g., set back to the default or previous priority level, and/or the priority level lowered by a configured delta level from the current priority level, etc.).

A WTRU may be configured with different thresholds/levels, for example for different parameters/variables (e.g., as herein) (e.g., WTRU battery level, time remaining and elapsed time, time since collected data reporting has been requested, congestion level, NES state, non-data collection data volume, serving cell radio conditions, and/or occurrence of events, etc.). Additionally, or alternatively, the WTRU may be configured with different thresholds/levels for corresponding priority levels for the data collection logical channel. The WTRU may be configured with a formula and/or scaling factor to map the change in the parameter value to the priority (e.g., as compared to the default/initial priority of the logical channel or the previous priority that was assigned to the logical channel, etc.).

There may be an explicit change of the priority of data collection logical channels. A dynamic way of modifying the priority at the WTRU based on a set of conditions/thresholds is described herein. Additionally, or alternatively, the WTRU may receive a (e.g., explicit) message from the network to change the priority of one or more data collection logical channels. The (e.g., explicit) message may be an RRC message (e.g., a dedicated RRC message, and/or a broadcast message, etc.). Additionally, or alternatively, the (e.g., explicit) message may be a MAC CE and/or a DCI.

The WTRU may receive a MAC CE that indicates the concerned logical channel(s) and/or the new priority. For example, the MAC CE may not explicitly indicate the new priority, but may for example indicate whether the priority is to be increased/decreased (e.g., to the next higher/lower possible value that can be taken by the priority, and/or indicate multiple level changes in just one message).

There may be a validity of the priority level change. The increase/decrease of the priority level of the data collection logical channel (e.g., as herein) (either dynamically by the WTRU based on conditions or based on explicit indication from the network) may be associated with a validity/expiry time (e.g., the priority may be reverted to the previous/default value after the configured validity time duration has elapsed). The same or a different validity time duration may be configured for increasing and/or decreasing the priority level. If multiple level increase/decrease are allowed for example, there may be different timer durations associated with the length of the step increase/decrease. For example if the priority has increased by 1 step, the validity time duration may (e.g., then) be set to t1. If the priority has increased by 2 steps for example, the validity time duration may (e.g., then) be set to t2, e.g., t2=t1/2, etc.

The validity/expiry time may be combined with the buffer level thresholds. For example the validity/expiry time and the buffer level thresholds may be fulfilled to trigger the raising/lowering of the priority, and/or the fulfillment of either to trigger the raising/lowering of the priority, etc. The WTRU may be configured with the maximum and/or minimum priority levels/values, that for example may be assigned to the data collection logical channels and/or the (e.g., different) increase/decrease of the priority (e.g., at one time).

A (e.g., some) parameter(s), for example the validity time, and/or affected data collection bearer(s)/logical channel(s), etc. may be included in the (e.g., explicit) message received from the network (e.g., MAC CE). Additionally, or alternatively, the WTRU may be pre-configured with the parameter(s) values separately from the message (e.g., in previous messages, e.g., MAC/LCH/bearer configurations, and/or values indicated in 3GPP standards, etc.). For example, different MAC CEs and/or LCID values to be used by the MAC CEs may be specified. The MAC CEs and/or LCID values may (e.g., each) be associated with different prohibit/validity timers and/or with different data collection use cases. For example LCIDx may be associated with AI/ML data collection and/or LCIDy for sensing. When the WTRU receives a MAC CE that uses LCIDx for example, the WTRU may infer that this is concerning AI/ML data collection logical channels. When the WTRU receives a MAC CE that uses LCIDy for example, the WTRU may infer that it is intended for the data collection logical channels related to sensing, etc.

BSR formats are disclosed herein. For example there may be separate BSRs concerning collected data logical channels. The WTRU may be predefined and/or configured to report a buffer status of data collection bearers, for example in a separate BSR. The WTRU may be predefined and/or configured to trigger a separate BSR for a subset of (e.g., one or more) BSR triggering conditions. Example BSR triggering conditions may include a data volume trigger condition, a time to discard trigger condition, a priority of newly arrived data being higher than other data from data collection bearers that have already been reported, a priority of the newly arrived data (e.g., at MAC) being higher than the priority of other data from other bearer types (e.g. SRBs and/or DRBs), the priority of the newly arrived data being higher than a configured threshold.

The WTRU may trigger a separate BSR if buffered data from the associated bearer(s) is greater than a configured threshold, for example for the data volume trigger condition. The WTRU may trigger a separate BSR if the remaining time until data is discarded falls below a configured threshold, for example for the time to discard trigger condition. The remaining time associated with the SDU may be a remaining time determined by the WTRU. For example the WTRU may determine the remaining time to be a time until the bearer's/SDU's discard timer associated with the packet expires (e.g., where such timer may be maintained at higher layers, PDCP, and/or by MAC).

Additional or alternative BSR triggering conditions may include data belonging to a bearer from a specific data type (e.g. AI/ML, and/or sensing, etc.), a data type of the newly arrived data not being reported (e.g. in a previous BSR), data belonging to a bearer configured for data collection, the trigger occurring during a period (e.g. a time in the day) that is configured by the network, the trigger occurring during a period following the reception of an indication from the network (e.g. in a MAC CE and/or a DCI, and/or probing the possibility of data collection reporting and/or transmission), and/or expiration of a periodic triggering timer.

The WTRU may group LCHs (e.g., bearers), for example in a separate BSR format/design. Additionally, or alternatively, the WTRU may group LCHs (e.g., bearers) configured for data collection by data type, data priority and/or group of priorities, and/or termination point (e.g. NWDAF entity, OAM server, and/or ML OTP server). Priority grouping values may be configured, for example for the data priority and/or group of priorities. Grouping of LCHs may be configured. A termination point may be abstracted by one grouping index configured per LCH for example.

The separate BSR may be transmitted with lower priority (e.g. in LCP) than the regular BSR MAC CE (e.g. for other bearers, including SRB and DRB LCHs). The separate BSR may be transmitted, for example if the regular BSR is not triggered and/or not multiplexed in the grant. The separate BSR may be transmitted, if there is no other data multiplexed in the grant from other bearers, for example including SRB and DRB LCHs. Additionally, or alternatively, the separate BSR may be transmitted, if the data is lower than a configured priority. The separate BSR may be multiplexed as a padding BSR, for example if space allows instead of padding bits.

Once the WTRU transmits a separate BSR for example, the WTRU may start a prohibit timer. The prohibit timer may prohibit the triggering and/or multiplexing of another separate BSR, for example until the prohibit timer expires. The WTRU may restart the prohibit timer, for example upon transmitting a regular BSR, a separate BSR, receiving a grant, and/or receiving an indication from the network to suspend reporting of collected data (e.g. on data collection bearers).

The separate BSR may have one or more formats. Example formats may include full BSR, truncated BSR, and/or padding BSR. Full BSR may be triggered by a trigger (e.g., as discussed herein). Full BSR may be referred to as regular BSR. Truncated BSR may include where a subset of LCGs/LCHs may be reported, for example depending on the remaining space in the grant. Additionally, or alternatively, truncated BSR may be where the LCGs/LCHs of the highest priorities may be reported. Padding BSR may be included when there are sufficient padding bits to report one or more LCGs from data collection bearers.

A format for the separate BSR may be predefined, configured (e.g. per MAC entity), or may be a capability. A BSR triggered by arrival of new data from data collection bearers may or may not trigger an SR. SR may be triggered, for example conditionally triggered, based on a data volume condition, a time to discard trigger condition, a priority of newly arrived data being higher than other data from data collection bearers that have already been reported, a priority of the newly arrived data (e.g., at MAC) being higher that the priority of other data from other bearer types (e.g., SRBs and/or DRBs), a priority of the newly arrived data being higher than a configured threshold, the data belonging to a bearer from a specific type (e.g., AI/ML, and/or sensing, etc.), the data type of the newly arrived data not being reported (e.g., in a previous BSR), and/or the data belonging to a bearer configured to data collection. The WTRU nay trigger the SR if buffered data from the associated bearer(s) is greater than a configured threshold, for example for the data volume condition. The WTRU may trigger the SR if the remaining time until data is discarded falls below a configured threshold, for example for the time to discard trigger condition.

The SR triggered by data collection bearers may configured with a separate SR configuration (e.g., configuration information) and/or PUCCH resource, for example where the SR may be transmitted on those resources. The WTRU may start a data collection SR prohibit timer, which for example may not prohibit the triggering of another SR trigger by other bearers (e.g. SRB or UP DRBs). The WTRU may, for example while the SR prohibit timer is running, not transmit another SR triggered by arrival of collection data.

There may be combined BSR for collected data logical channels and other logical channels. The WTRU may be predefined and/or configured to report buffer status of data collection bearers in a combined report along with other bearers. The WTRU may include buffer status bearers from data collection bearers, for example if one or more of the triggers (e.g., as herein) (e.g. for separate BSR triggering) is met.

The combined BSR may have a format distinguished by different LCIDs. One example format may include data collection LCHs/LCGs/bearers (e.g. if one or more condition is met). Another example format may include buffer status of other bearers (e.g. SRB and/or UP DRBs).

Combined BSR with data reporting may be referred to as combined BSR. For the combined BSR with data collection reporting for example, the combined BSR may include one or more LCGs for the purpose of reporting data collection buffer status. The LCHs may be grouped by all data collection together (e.g. if one bearer is used), data type, data priority or group of priorities (e.g., where priority grouping values can be configured), LCG (e.g., where grouping of LCHs may be configured), and/or a termination point (e.g. NWDAF entity, OAM server, and/or ML OTP server). The termination point may be abstracted by one grouping index configured per LCH.

The WTRU may prioritize which bearers/data types to include in the combined BSR buffer status report. For example the WTRU may prioritize which bearers/data types to include in the combined BSR buffer status report by data type, data priority and/or group of priorities, LCG, and/or termination point. There may be a predefined and/or configured priority list (e.g. AI data, model transfer data, sensing data, and/or ML data, etc.), for example for the data type. Priority grouping values may be configured, for example for data priority and/or group of priorities. Grouping of LCHs and/or LCG priorities may be configured and/or determined as the highest priority LCH amongst the LCHs in the LCG. A subset of data collection LCGs/LCHs may be configured to be reported in the combined BSR in some examples. A termination point may be abstracted, for example by one grouping index configured per LCH. Additionally, or alternatively, the WTRU may be configured with a priority per termination point.

The number of data collection LCGs in the combined BSR may be variable, for example where the number depends on a configuration and/or the amount of space (e.g. octets) remaining in the grant. An LCID and/or an extension bit may be used to indicate the number of LCGs included in the combined BSR. A reserved bit may be used to indicate whether the BSR is a combined BSR (e.g. one that contains buffer status info for data collection LCG/LCHs/bearers)

The WTRU may (e.g., then) use the prioritization list (e.g., as discussed herein) to determine which data collection LCG to include in the combined BSR. For example, the WTRU may determine the amount of data collection LCGs to include in the combined BSR as a function of the number of padding bits/octets. The WTRU may include 2 data collection LCGs in the combined BSR, for example if the number of padding bits is 20 bits and/or if LCG requires one octet for buffer status indication. BSR may be supported as predefined, configured (e.g., per MAC entity), and/or as a capability. A format may be predefined, configured (e.g., per MAC entity), and/or as a capability.

The WTRU may be configured to not trigger a BSR/SR in relation to data collection. The WTRU may be configured to (e.g., instead) use another signaling (e.g., new MAC CE, and/or RC message), for example indicating that a collected data is available. The WTRU may send the indication, for example when one or more of the conditions (e.g., as herein) are fulfilled (e.g., collected data volume is above a certain threshold, etc.). The WTRU may be predefined and/or configured to report data collected but not yet made available to PDCP/RAN user plane layers, for example in a separate report.

The WTRU may include (e.g., additional) information about the collected data in the indication (e.g., how much data is available, validity/expiry time, the bearer(s)/logical channel(s) that triggered the indication, etc.). The WTRU may receive a response message, for example from the network. The response message may indicate that the WTRU may send the data. The indication may include (e.g., additional) information, for example such as the amount of data to be sent, time duration when such data may be sent, and/or the concerned data collection bearer(s)/logical channels, etc.

The WTRU may resume a suspended data collection bearer, for example upon receiving an indication from the network. If information about the time duration is included in the response from the network for example, the WTRU may suspend the bearer after the time duration has elapsed after the reception of the message. If information about the amount of data to be sent is included in the response from the network for example, the PDCP/RLC of the bearer may make only a maximum of that amount of data to be delivered available to MAC before suspending the bearer again.

The WTRU may enable the triggering of BSR/SR for the data collection bearer(s), for example based on the response message received from the network. If information about the time duration is included in the response from the network for example, the WTRU may disable the triggering of BSR/SR based on the data of the concerned data collection bearer(s).

The WTRU may receive a response message from the network, for example indicating to change (e.g., some of the) characteristics/configuration of the data collection bearer(s) and/or associated logical channels. For example the WTRU may receive a response message (e.g., RRC message, MAC CE) that may change the logical channel configuration (e.g., temporarily for a certain duration, until a certain amount of the collected data is sent, until another message is received from the network indicating to change the configuration to the default/previous values, etc.). The change may include a change in the logical channel priority and/or logical channel grouping of the bearer. The change may (e.g., then) affect how data belonging to the bearer will impact BSR/SR triggering.

The WTRU may receive a message from the network (e.g., modifying the characteristics/configuration of a data collection bearer(s)/logical channel(s), indicating to resume/suspend the bearer, and/or enable/disable the BSR/SR triggering), for example without sending an availability indication. The network may determine the need and/or opportunity to send the collected data, for example by itself and/or in communication with an external data collection server. The WTRU may apply the configured behavior, for example until a certain duration has elapsed and/or until a subsequent message is received to revert to previous/default configuration, etc.

1. A wireless transmit/receive unit (WTRU) comprising:
a processor, the processor configured to:
receive configuration information comprising an indication of one or more conditions associated with collected data, wherein the indication of the one or more conditions associated with the collected data comprises an indication of a volume threshold;
collect data;
compare the collected data to the volume threshold;
based on the comparison of the collected data to the volume threshold, perform one or more of the following:
allow access to the information associated with the collected data to one or more lower layers;
transmit an indication to a network that the collected data is ready for transmission; or
restrict access to the to one or more lower layers to the collected data.

2. The WTRU of claim 1, wherein the one or more lower layers comprise a Packet Data Convergence Protocol (PDCP) layer or a Radio Link Control (RLC) layer.

3. The WTRU of claim 1, wherein the processor is configured to:
receive an uplink (UL) grant; and
transmit the collected data to the network via resources indicated by the UL grant.

4. The WTRU of claim 1, wherein the processor is further configured to restrict access to the collected data for determining an amount of data.

5. The WTRU of claim 1, wherein the processor is configured to determine, based on the one or more conditions, an amount of data to transmit to the network.

6. The WTRU of claim 1, wherein, to restrict access to the to one or more lower layers to the collected data, the processor is configured to prevent the one or more lower layers from using the collected data when performing a data volume calculation.

7. The WTRU of claim 1, wherein the processor is configured to:
suspend a data collection bearer based on the collected data being below the volume threshold.

8. The WTRU of claim 1, wherein the processor is configured to:
disable a triggering of a buffer status report (BSR) or scheduling request (SR) based on the collected data being below the volume threshold.

9. The WTRU of claim 1, wherein the processor is configured to, based on the comparison of the collected data to the volume threshold, allow access to the collected data to the one or more lower layers.

10. A method performed by a wireless transmit/receive unit (WTRU), the method comprising:
receiving configuration information comprising an indication of one or more conditions associated with collected data, wherein the indication of the one or more conditions associated with the collected data comprises an indication of a volume threshold;
collecting data;
comparing the collected data to the volume threshold;
based on the comparison of the collected data to the volume threshold, performing one or more of the following:
allowing access to the information associated with the collected data to one or more lower layers;
transmitting an indication to a network that the collected data is ready for transmission; or
restricting access to the to one or more lower layers to the collected data.

11. The method of claim 10, wherein the one or more lower layers comprise a Packet Data Convergence Protocol (PDCP) layer or a Radio Link Control (RLC) layer.

12. The method of claim 10, comprising:
receiving an uplink (UL) grant; and
transmitting the collected data to the network via resources indicated by the UL grant.

13. The method of claim 10, comprising restricting access to the collected data for determining an amount of data.

14. The method of claim 10, comprising determining, based on the one or more conditions, an amount of data to transmit to the network.

15. The method of claim 10, wherein restricting access to the to one or more lower layers to the collected data comprising preventing the one or more lower layers from using the collected data when performing a data volume calculation.

16. The method of claim 10, comprising suspending a data collection bearer based on the collected data being below the volume threshold.

17. The method of claim 10, comprising disabling a triggering of a buffer status report (BSR) or scheduling request (SR) based on the collected data being below the volume threshold.

18. The method of claim 10, comprising, based on the comparison of the collected data to the volume threshold, allowing access to the collected data to the one or more lower layers.
